(19) United States
(12) Patent Application Publication
(10) Pub. No.: US 2023/0074830 A1
(43) Pub. Date: Mar. 9, 2023

(54) METHOD AND SYSTEM FOR PROTECTING AMATEUR STATUS OF STUDENT ATHLETE COMPRISING NOVEL APPLICATIONS WITHIN SERVICE WORK, LICENSING OF GOODS FOR SALE, AND INDUSTRY-STANDARD FEES WITHIN FORMULA FOR COMPENSATION

(71) Applicant: James BEECHAM, West Palm Beach, FL (US)

(72) Inventor: James BEECHAM, West Palm Beach, FL (US)

(21) Appl. No.: 17/947,143

(22) Filed: Sep. 18, 2022

Related U.S. Application Data
(63) Continuation-in-part of application No. 17/470,193, filed on Sep. 9, 2021, now abandoned.
Application No. 17/470,193 is a continuation-in-part of application No. 17/582,875, filed on Jan. 24, 2022, now abandoned.
Application No. 17/582,875 is a continuation-in-part of application No. 17/825,917, filed on May 26, 2022.
Application No. 17/825,917 is a continuation-in-part of application No. 17/844,221, filed on Jun. 20, 2022.
Application No. 17/844,221 is a continuation-in-part of application No. 17/882,870, filed on Aug. 8, 2022.

(51) Int. Cl. G06Q 30/02; G06Q 50/10; G06Q 50/20

(52) U.S. Cl. CPC G06Q 30/0273; G06Q 50/10; G06Q 30/0279; G06Q 50/2053

(57) ABSTRACT

The present invention includes method and system for student athlete compensation within rules of keeping amateur status, said compensation associated to fundraising services provided by said student athlete. In a preferred embodiment, said system comprising computer processor and memory comprising logic, said logic directing link in computer be established between a name of a student athlete and at least one documentation of said student athlete participating in said fundraising. In a preferred embodiment, said fundraising comprising at least one presentation by a student athlete to at least one potential buyer of at least one ad regarding sale online of good licensed by said athlete. In a preferred embodiment, said license comprising permission for configuring within said good of at least one of said athlete's name, image, and/or likeness.

### CROSS-REFERENCE TO RELATED APPLICATIONS

The present application is a continuation in part application to U.S. Non-Provisional application Ser. No. 17/470,193 filed 9 Sep. 2021 entitled ‘METHOD AND SYSTEM FOR SPORTS ATHLETE SELLING USE-OF-NAME LICENSE TO FAN TO ENABLE DISPLAY OF SAID ATHLETE NAME IN AD ENDORSEMENT OF TEAM SPIRITEDNESS OF SAID FAN ON SAID FAN SOCIAL MEDIA PAGE’, and to non-provisional application Ser. No. 17/582,875 filed 24 Jan. 2022 entitled ‘ONLINE LICENSING PLATFORM WITH ADDITIONAL FEATURES’, and to non-provisional application Ser. No. 17/825,917 filed 26 May 2022 entitled ‘ONLINE LICENSING PLATFORM COMPRISING PRE-AUTHORIZATION BLOCK, RATINGS OF ATHLETES’ PLATFORM-RELATED ACTIVITIES, LINK TO VIEW AMATEUR ATHLETE ONLINE SOCIAL MEDIA POSTS, AND LIVE STREAMING′, and to non-provisional application Ser. No. 17/844,221 entitled A COMPUTERIZED SYSTEM AND METHOD FOR IMPROVING EFFICIENCY OF SALE AND PURCHASE OF NAME, IMAGE AND LIKENESS (NIL) LICENSES, and to U.S. Non-Provisional application Ser. No. 17/882,870 filed 8 Aug. 2022 entitled ONLINE LICENSING PLATFORM COMPRISING COORDINATED USE OF ONLINE-VIEWABLE TEAM ROSTER AND LINKED MICRO BLOG, the disclosures of which are hereby incorporated in their entirety at least by reference.

### BACKGROUND OF THE INVENTION

### 1. Field of the Invention

The present invention generally relates to method and system for efficient organizing of computer and physical components comprising documentation of service work by student athlete, such organizing serving to protect amateur status of said student athlete while athlete is paid for said service work and while license granted by said student athlete facilitates marking of good for sale within system. More specifically, instant invention comprises payment of student athlete using formula comprising royalty percent pay for licensing and pay by percent for service works, said service work comprising at least one of fundraising, publicist work, teaching, and providing passerby a viewpoint of student athlete participant.

### 2. Description of Related Art

Prior art may include U.S. Pat. No. 10,832,292 to Tierney.

### BRIEF SUMMARY OF THE INVENTION

One embodiment of present invention comprises a method for compensating a student athlete licensing goods within instant invention sales system, said method comprising a step of documenting said student athlete's participation in fundraising, publicist work, teaching, and providing passerby a viewpoint of student athlete participant in system. One advantage of this arrangement over other compensation schemes for student athletes that emphasize star athletes, is that within instant invention, more student athletes of lesser renown or sports skills and more fans are likely to be involved.

In a preferred embodiment, said system comprising computer processor and memory comprising logic, said logic directing link in computer be established between a name of a student athlete and at least one of documentation comprising evidence of system-linked service work by said student athlete, and compensation calculated as due said student athlete.

In a preferred embodiment, said documentation linked to student athlete name in computer memory comprises link to an amount said student athlete's-licensed goods fetched in sale. In a preferred embodiment, said amount comprises a figure used in percent formula calculation to determine compensation payable to said student athlete (see FIG. 9). Typically, from student athlete-licensed goods selling to fans in a website of instant invention (website herein referred to as FHP or Fans Help Players), said monies are routed to system administration (system administration herein also referred to as CA or CollectiveAlums). Herein, system website is linked to CollectiveAlums which is thus linked to website's database for sales of badges under license from student athletes. In a preferred embodiment, said links established in computer can comprise student athlete name linked to said student athlete's registration number in system, and further said link comprising said registration number is linked to URL for YouTube channel of said student athlete, said channel comprising a series of videos displaying said student athlete performing service work duties within system (see FIGS. 3 and 4), such as student presenting to passerby a card (see FIG. 5). Said videos typically reflect multiple such examples of service work by said student athlete over a period of weeks and months. In a preferred embodiment, said videos are each marked with time/date stamp. In a preferred embodiment, an official can review said linked documentation to verify said nature and timeframe of such completed service work. Said verification assists officials with verifying compliance to rules for compensation of student athletes, and to preserve student athletes' amateur status.

In a preferred embodiment, calculation of pay for licensing and service work by student athlete is based on use of formula comprising multiplying the total amount of funds raised by sales of goods as licensed by a specific student athlete times a percent agreed (see FIG. 9).

In a preferred embodiment, said fundraising within instant invention comprising at least one presentation, such as a form of ad being presented by a student athlete to at least one potential buyer or passerby of at least one good licensed by said athlete within system. In a preferred embodiment, said license approved by said student athlete comprises said athlete's permission for use of at least one of said athlete's name, image, likeness. In a preferred embodiment, said at least one presentation of ad comprising at least one reference in ad using visual component, or audible component, or both, to alert passerby of at least potential of how at least some funds of a fan's purchase of student-athlete-licensed good could fund the alma mater school of the student athlete authorizing said licensing. Typically, the student athlete in publicizing the benefits of the system can mention likelihood that funds from sale of a licensed good of the system could help other student athletes of same school (alma mater). Where money raised in in small amount per good sold, this aspect can be perceived as comprising the system of many fans and athletes. This wide participation of fans and athletes can stimulate more excitement in the fan base as they perceive the team as more supported by their own efforts.

In a preferred embodiment, said presentation of ad further comprising at least one of visible display and audible display associated to handing out cards, said cards typically listing the website address where licensed goods are available (FIG. 5) and/or the registration number at that website which corresponds to student athlete making presentation. Said registration number when entered into the search bar of website search, provides for potential buyer of licensed badge, a view of student athlete online profile, such as photo, video and social media links. In a preferred embodiment, said proof of student athlete having done system-related service work, said documentation can further comprise at least one image of said student athlete making above disclosed presentation of ad to passerby, optionally with said image posted online to view of public. In a preferred embodiment, said documentation can comprise time/date notated on photo of member of public listening to ‘pitch’ of ad with image comprising said student athlete making said ‘pitch’. Optionally, said work-documenting photo can be signed by said member of public, such as a polaroid photo, as further documentation. Said images and said certifying documents typically become part of a record which system, or individual student athlete, makes and keeps. For example, individual student athlete can take such photos, mark the by date, and store them in his cell phone's memory. Such documentation is useful for proving said student athlete participated in specific service work related to system, such as presentation of ads, publicizing website of system, encouraging more badge purchases, i.e., fundraising. In a preferred embodiment, such documentation can be proof which is offered to investigator working for rule-making authority of amateur athletics, said proof that amateur athlete received compensation for bone fide service work, compensation that was not ‘pay for play’.

In a preferred embodiment, said system further comprising payment to said fundraising student athlete, said payment issued by system administration (herein called a collective) for which payment that student athlete's licensed goods raised the funds. In a preferred embodiment, said system further comprising establishment by said system administration (collective) of an educational trust at school where student athlete is enrolled, said trust comprising at least some of said student-athlete-raised funds in use to help other athletes of school, possibly athletes of lesser renown.

In a preferred embodiment, said system further comprising review by certifying authority of documentation online of YouTube videos as proof a specific student athlete of system did perform the service work for which he was paid. Said review can result in a series of positive evaluations, and such evaluations of all student athletes within a Department of Athletics can provide at least a snapshot of that Department's compliance to rules of amateur athletics.

In a preferred embodiment, instant invention comprises a system for documentation for proof student athlete compensation is justified as per amateur athletics rules, said system comprising a student athlete in receipt of pay from system administration (collective), said pay verified to correspond to standard fees within industry. In a preferred embodiment, school official appoints official to correspond with instant invention system administration, such correspondence regarding funds paid to student athletes of said school.

In a preferred embodiment, instant invention system further comprising a collective, said collective comprising an organization of persons interested to promote adequate funding of student athletes within the rules. In a preferred embodiment, said collective collects and stores data regarding amount of funds raised by a specific fundraising student athlete, such as by sale of goods within system. In a preferred embodiment, said collective receives sales proceeds from sale of student athlete licensed goods. In a preferred embodiment, said collective calculates a compensation to said fundraising student athlete as a percent (see FIG. 9).

In a preferred embodiment, said system further comprising at least one license authorized by said student athlete, said at least one license comprising authorization to use at least one of said student athlete's name, image, and likeness in composition of goods for sale. In a preferred embodiment, said goods can be an electronic file configured as badge, said badge downloadable Typically, the license is time-limited, and upon expiry, the buyer is instructed to remove the badge from their social media page.

In a preferred embodiment, instant invention system further comprising preservation of student athlete service work documentation. In a preferred embodiment, said system further comprising at least one review by certifying authority of said documentation of said student athlete's activity. In a preferred embodiment, said review at least facilitated by access to said memory-stored files by use of URL provided by student athlete.

In a preferred embodiment, said certifying authority reports to Department of Athletics regarding their results of review. In a preferred embodiment, said reports are stored in computer memory with said Department of Athletics, such as under supervision of data manager.

In a preferred embodiment, instant invention comprises at least one of list: presentation of ad to passerby, garment bearing advertisement, card bearing online address, card bearing student athlete's registration number, formula using percentage, registration number displayed to passerby. In a preferred embodiment, instant invention comprises method of compensating a student athlete while said student athlete abides by rules for maintaining amateur status.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a chart of activities and relationships of a preferred embodiment.

FIG. 2 is a chart listing steps of a preferred embodiment.

FIG. 3 is an illustration of a preferred embodiment

FIG. 4 is an illustration of a preferred embodiment

FIG. 5 is an illustration of a preferred embodiment

FIG. 6 is a schematic with text of a preferred embodiment

FIG. 7 is a schematic with text of a preferred embodiment

FIG. 8 is a chart comprising a notice within a preferred embodiment

FIG. 9 is a chart comprising a formula for compensation

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art since the general principles of the present invention have been defined herein to specifically provide protection for amateur status of student athlete comprising novel applications within service work, licensing of goods for sale, and industry-standard fees within formula for pay to student athletes performing said service work.

The word “a” is defined to mean “at least one.”

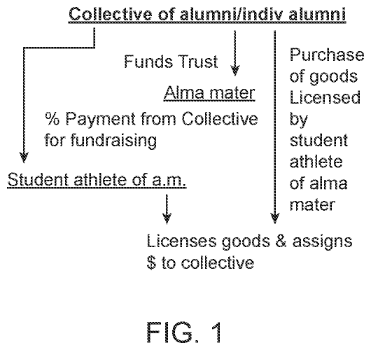

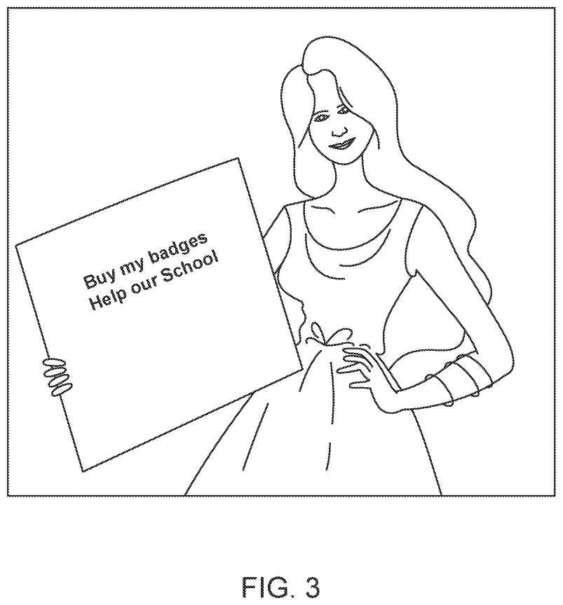

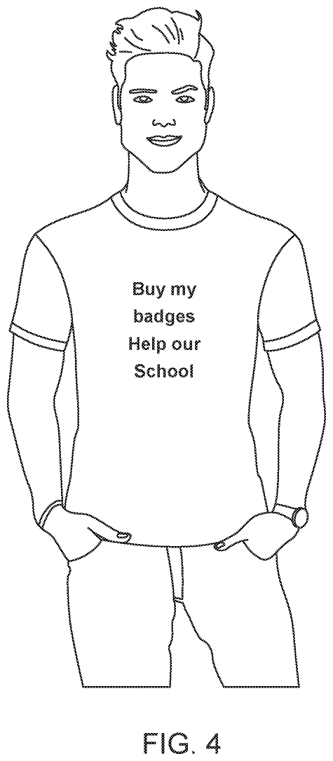

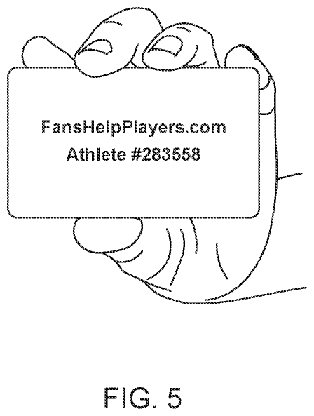

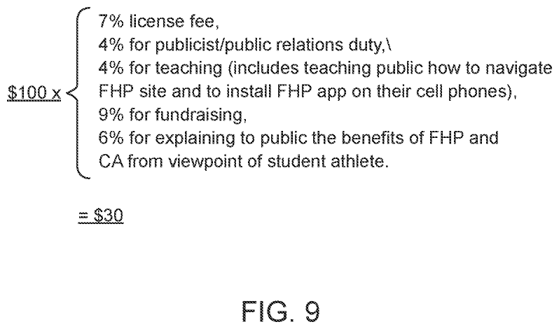

FIG. 1 is a chart of activities and relationships of a preferred embodiment. A student athlete of a.m. (alma mater) has authorized marking of goods via license, such as to bear athlete's name and/or image and/or likeness. Said athlete assigns rights to collect license earnings to system administration (a collective) in exchange for a contract to be paid for student athlete performance of service work. Said collective has in its mission statement a goal of providing funds to student athletes and schools, such funds provided within context of following rules of amateur athletics. The student athlete participates in fundraising activities, such activities comprising said student athlete wearing a tee shirt with words disclosing to passers-by at least one of details of the said offer of licensed goods on sale (see FIGS. 3 and 4) and/or the name of the website where said sale can be accessed. The student athlete when asked by a passerby about the tee shirt's words, said student athlete speaks about the mission of protecting student athlete amateur status while enabling student athlete to earn money. Student athlete can mention his assignment of sales proceeds, and how this provides him pay for duties such as the education he is providing the instant member of the public he is speaking to. Student athlete hands said inquiring passerby a card (see FIG. 5) which displays the website address where such goods are on sale, said card further displaying the online address of the website of the system. Student athlete speaks with the passerby and explains that he himself receives pay as fundraiser. Student athlete explains that the system can fund a trust fund at his school, said trust administered by a trustee appointed by the alma mater President and Director of Athletics. Student athlete explains that said trust comprises dispersing funds to needy student athletes. In FIG. 1, a group of alumni (right side arrow) visit the website where said licensed goods are for sale and said visiting online alumni purchase some of the goods. Such purchases are accounted for in the computer of the system. The money from said purchase is routed within system to bank account linked to system administration. The system computer records and processes the amount of such purchases total by month as linked in computer to each such student athlete accountable to licensed good sold. At the time of sale or at the end of the month, the student athlete receives a check to pay said student athlete (see FIG. 9).

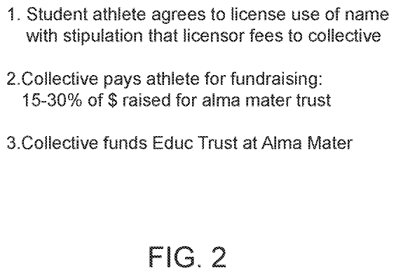

In FIG. 2, steps of a preferred embodiment are listed in a chart. Said steps comprise agreement by student athlete to license goods, said goods comprising by said license a marking comprising said student athlete's name and/or image and/or likeness. Said agreement further indicates said student athlete's agreement to work as fundraiser, and to accept, as full payment, a pre-agreed percent (see FIG. 9).

FIG. 3 is an illustration of a preferred embodiment wherein a student athlete is dressed in street clothes and carries a sign which bears words ‘Buy my badges, Help our School’. The dress is not a sports uniform of the school, an important distinction if the school rules forbid school uniform use in private fundraising. School optionally can allow such fundraising activities on campus, especially where a trust fund of system is provided to school. For example, student athlete, if allowed, can walk along the paths of the campus, answering inquiries about his sign (persons inquiring are not shown). Student athlete can take selfie photo of himself and the person for whom student athlete presents an ad, said selfie disclosing the ad on tee shirt of student athlete and the passerby. A videographer (not shown) is optionally allowed by school to record on campus a video of student athlete making a ‘pitch’, such video time/date stamped, a video with audio, said video comprising documentation of student athlete's participation in fundraising. Said video is typically sent by videographer to Department of Athletics or retained in records of student athlete, such as his YouTube channel. Said documentation is available for review by officials of NCAA or other governing body, to verify that said student athlete's pay was within rules. Per rules of amateur athletes, services rendered are legitimate sources of pay if truly rendered by student athlete, and so long as this service is not a school sporting event participation ‘pay for play’ by said student athlete.

FIG. 4 is an illustration of a male student athlete wearing a tee shirt with same words as FIG. 3. The student athlete, when encountering a passerby, can ask if they love their school sports teams. The passerby can answer ‘yes’, which answer prompts the student athlete to ask if the passerby has a minute to learn about how fans can help athletes at the school. This conversation is opportunity for male student athlete to teach the passerby how the instant invention operates, and how the passerby can assist.

FIG. 5 is an illustration of a preferred embodiment displaying a business-style card bearing the online address of the website wherein said FIG. 3 and FIG. 4 student athletes' licensed goods are on sale, and the registration number of said card-dispensing student athlete within said website database. The passersby who see the tees shirt and card can ask the student athlete to show passerby on his or her cell phone (not shown) how to access the linked profile of the student athlete and access the mechanism for buying a badge endorsing said passerby TEAM SPIRIT, said endorsement by card-dispensing student athlete. The student athlete and passerby can complete the badge purchase and posting on passerby social media, all on passerby cell phone, all completed in just a minute or two.

It is understood that a school season is typically nine months, with a lull in activity during the summer. It is understood that a sports season at school, such as basketball season, is typically three months of the usual nine-month school ‘year’. It is understood that students have interests and obligations that wax and wane over the school year, such as more studying required during ‘finals week’ or more focus on football during Homecoming. Thus, the activity of fans and student athletes, non-athlete students, and others in the school environment as to instant invention when used on campus, such effects can increase or decrease activity. In a preferred embodiment, all remuneration due said student athlete can be more quickly settled when said campus activity is high, and student athlete need is greater, even if student athlete temporarily is only intermittently performing service duties.

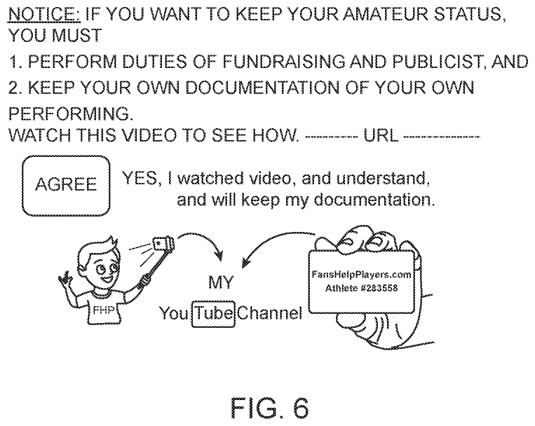

In FIG. 6 is a schematic with associated text of a preferred embodiment, in which a notice is made to student athletes pre-registration at site, typically with instant notice required to be agreed by click of button prior to approval of user student athlete's registration. The notice lists the order of tasks which need to be done by a student athlete in making as sure as possible that his or her amateur status is preserved. The steps are to perform service duties, such as fundraising and publicist work, and to document said activity. A tutorial video URL is provided, by which student athlete watching said video is instructed how to document and then post documentation on YouTube. Said tutorial video further comprises details of how to interact with passersby, as disclosed above. The computer system is programmed to refuse registration to continue until and unless the student athlete clicks the ‘Agree’ computer button. Said click affirms the student athlete's understanding of the above disclosed documentation process, and further confirms intent of student athlete to comply. The programming of the computer system has a ‘go’ and ‘no go’ component. The ‘no go’ is the default setting. The setting can be changed to ‘go’ only by click on ‘agree’ button. Only with attaining the ‘go’ status does the programming allow registering of said student athlete. The click on ‘agree’ button also signals student athlete having watched the instructional video, having understood it, and express his or her intent to correctly keep the documentation that bolsters registered student athlete's chance of maintaining his or her amateur athlete status intact. At the bottom of FIG. 6 the notice, an illustration or schematic appears which summarizes immediately the working of documentation system. The figure on the left (same figure as used in the video) is shown wearing a tee shirt with letters ‘FHP’ which represent Fans Help Players', the website of preferred embodiment wherein student athletes offer for sale their licensed goods, and where fans can buy them. The figure of a male athlete (in FHP tee shirt) is depicted with cell phone on a selfie stick, such illustration reminding registering student athlete of need to document his or her service work by image, such as by video. The curved red arrow from the cell phone to the words ‘My YouTube Channel’ is a reminder to registering student athlete to post said video of selfie documenting student athlete in carrying out service work to educate a member of the public. At bottom right of FIG. 6, an illustration of a hand holding into view a business-type card is depicted. The said business card is understood to be in hand of student athlete performing service work of publicist within system. The writing on the card comprises information visible to passerby and useful for student athlete to explain to passersby how the instant invention system is used. The website address is listed. The registration number of the student athlete is also listed. In the case where the passerby has a cell phone and requests a demonstration, the student athlete can direct the passerby with cell phone to access the website and there to type in the registration number. The system responds with display of profile of student athlete, a photo of the same person as passerby sees in front of himself or herself. The photo in the profile matches the appearance of the student athlete standing there. The student athlete optionally directs the passerby to click the button of the profile which displays the names of three teammates of said student athlete, which teammates are listed therein as recommended by student athlete for fans to buy TEAM SPIRIT badge licensed good from as well. This method of educating the public allows the instant invention and service student athlete personnel working for the system, to increase sales, thus a fundraising activity, and one which the student athlete can record and store in cell phone files as documentation of his service work.

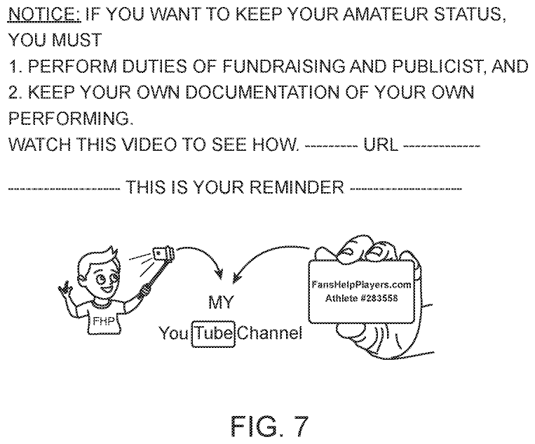

In FIG. 7, a schematic and associated text disclose a notice within instant invention, said notice comprising a reminder to registered student athletes of their need to pay attention to the two steps for assuring maintenance of their amateur status. The notice is sent to those student athletes who have already registered, i.e., who have already ‘agreed’ to their intent to comply with documentation requirement of system. The steps are listed in the reminder notice. The sending of this notice to registered student athletes within system, such as sent at regular intervals, such as weekly, provides a stimulus to all registered student athletes to complete the required two steps and thus increase their likelihood of retaining their amateur status, both individually and collectively. The illustration at bottom is identical to that of FIG. 6. The video URL could be the same as in FIG. 6, or optionally could be a different video link, as in a further installment in a series. The record of receipt of said notices is optionally made a matter of record within instant invention, as in a requirement that each student athlete click a response to acknowledge his or her receipt of the reminder. A response from each student athlete is useful to verify compliance, with follow-up directed to those student athletes not responding. This system allows more efficient remedial training to save the amateur status of those student athletes of system who have forgotten to keep their records up to date.

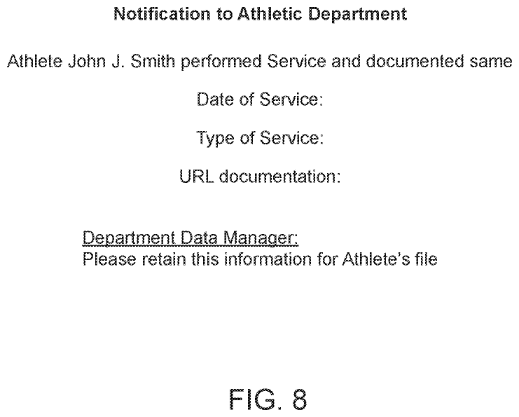

In FIG. 8, a chart of preferred embodiment comprises a notice to athletic department of a student athlete, said notice indicating that Athlete John J. Smith has performed service work and documented it. The date of said service is recorded (not filled here). The type of said service is documented (not filled here). The URL of the online posted video documenting said work is listed (not filled here). A note to the Athletic Department data manager requests the instant record be retained in the Department records of this athlete. By such procedure, enabled by and within instant invention, the process of monitoring and encouraging compliance of Departmental student athletes is streamlined.

FIG. 9 comprises a chart comprising a formula for compensation of student athletes in a preferred embodiment. Such student athletes as participating in instant invention have calculation of their pay using multiplication of amount of money raised from sale of goods bearing NIL by license of a student athlete. The calculation formula starts with amount of money raised (here listed as $100) and multiplies by percent fee associated to each of a plurality of service work performed by said student athlete and licensing granted by said student athlete. For example, a 7% licensing fee is applied, a 4% fee for publicist/public relations duty, a 4% fee for teaching (includes teaching public how to navigate FHP site and to install FHP app on their cell phones), a 9% fee for fundraising, and a 6% fee for explaining to public the benefits of FHP and CA from viewpoint of student athlete. The calculation yields a $30 payment for said student athlete. In a preferred embodiment, website notice provided within instant invention optionally comprises an explanation to interested public, as to how the remaining 70% of money is allocated and why. For example, student athlete can describe use of that 70% money as operating expenses such as taxes, salaries of personnel, insurance, training of staff, supply of tee shirts with FHP logo and with other words on tee shirt of cap or garment as associated to service work of student athletes. Additionally, said 70% is explained to supply business cards to student athletes performing service work, and to supply funding of educational trust at participating schools, and the like. Furthermore, the notice of explaining can include the fact that providing a student athlete a fee at above industry standard can attract the scrutiny of regulators of amateur athlete status, potentially endangering not just the one student athlete overpaid, but endangering the entire Athletic Department, such as when a team is barred from NCAA post-season play due to infractions of a few team players.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention

Reference to “first,” “second,” “third,” and so forth members throughout the disclosure (and in particular, claims) are not used to show a serial or numerical limitation but instead are used to distinguish or identify the various members of the group.

What is claimed is:

1. A system for establishing intent of student athlete to follow guidelines for documentation of service work performed by said student athlete, said system comprising a pre-registration block until and unless said student athlete signals to system computer an intent to follow guidelines for documentation of service work.

2. The system of claim 1, further comprising presentation by student athlete of ad to passerby, said ad comprising information regarding website of system, said website comprising sale of goods licensed by student athletes.

3. The system of claim 1, further comprising at least one of list: a reminder notice regarding need for student athlete to document service work, a record of documentation of service work sent to athletic department, a compensation formula for paying student athlete comprising at least one industry standard fee,

4. The system of claim 3, further comprising requirement for reminder notice to be responded to within computer system.

5. The system of claim 1, further comprising card bearing at least one of website address and student athlete's registration number.

6. The system of claim 1, further comprising compensation formula comprising a 7% licensing fee, a 4% fee for publicist/public relations duty, a 4% fee for teaching as including teaching public how to navigate system website, a 9% fee for fundraising, and a 6% fee for explaining to public the benefits of system from viewpoint of student athlete.

7. The system of claim 1, further comprising system registration number of student athlete in display to public.

8. A computerized system for documentation of student athlete service work payable within rules of amateur athlete retaining amateur status, said system comprising
a processor, memory linked to logic, said logic directing establishment of link between name of student athlete and at least one of documentation of service work by said student athlete and documentation of calculated pay due said student athlete.

9. The system of claim 8, further comprising reporting to athletic department of said documentation.

10. The system of claim 8, further comprising email notice reminder to student athletes of system.

11. The system of claim 8, further comprising a notice linked to a pre-registration block, said notice comprising procedure for documentation of service work, an associated video, and an agree button which releases the registration block.

12. The system of claim 8, further comprising pay to student athlete for service work, said pay comprising compensation for at least one of fundraising, publicist work, expression of viewpoint of student athlete regarding system, and hands-on instruction regarding computer operations of system,

13. The system of claim 8, further comprising online review of service work documentation.

14. The system of claim 8, further comprising card with printed website address.

15. The system of claim 8, further comprising card with printed student athlete registration number.

16. The system of claim 8, further comprising formula of compensation of student athlete for service work, said formula comprising proceeds associated to sale of badges licensed by a student athlete, said proceeds amount multiplied by each of a plurality comprising fee for student athlete authorizing license, fee for publicist duty by student athlete, fee for student athlete teaching member of public how to navigate system website and install system app on their cell phones, fee for fundraising by student athlete, fee for student athlete explaining to public the benefits of use of system from viewpoint of student athlete.

17. The system of claim 16, further comprising at least one education trust fund established with funding from system administration.

18. A method for allowing service work performed by a student athlete to be timely performed, documented and said documentation made reviewable, said method comprising steps:
participating by said student athlete in at least one of publicizing and fundraising, and
documenting said participation, and
storing said documentation in a computerized device, and
allowing said computerized device to comprise at least one of review by regulator and reminder message to student athlete.

19. The method of claim 18, further comprising teaching passersby.

20. The method of claim 19. further comprising displaying at least one of web address and student athlete registration number.
